(19) United States
(12) Patent Application Publication
(10) Pub. No.: US 2008/0174228 A1
(43) Pub. Date: Jul. 24, 2008

(54) Composition for dielectric layer and plasma display panel manufactured with the same

(76) Inventor: Jin-Keun Jung, Suwon-si (KR)

Correspondence Address: LEE & MORSE, P.C., 3141 FAIRVIEW PARK DRIVE, SUITE 500, FALLS CHURCH, VA, 22042, US

(21) Appl. No.: 12/007,526

(22) Filed: Jan. 11, 2008

(30) Foreign Application Priority Data
Jan. 18, 2007 (KR) 10-2007-0005627

(51) Int. Cl. H01J 17/49; H01B 1/08; H01B 1/02

(52) U.S. Cl. 313/485; 252/500; 252/520.4; 252/521.1; 252/520.2; 252/521.3; 252/518.1; 252/519.32; 252/519.3

(57) ABSTRACT

A dielectric layer composition includes a ceramic material, a binder, a solvent, and an additive, the additive being a selenium oxide additive or two or more of a selenium oxide, a vanadium oxide, a molybdenum oxide, and/or a cerium oxide.

### CROSS-REFERENCE TO RELATED APPLICATION

The present application is a related application of a co-pending U.S. patent application Ser. No. 11/822,349, entitled “Composition for a Barrier rib and Plasma Display Panel Manufactured with the Same,” which was filed on Jul. 5, 2007, and is incorporated by reference herein in its entirety.

### BACKGROUND OF THE INVENTION

1. Field of the Invention

Embodiments of the present invention relate to a composition for a dielectric layer and a plasma display panel (PDP) manufactured with the same. More particularly, embodiments of the present invention relate to a composition for a dielectric layer exhibiting enhanced thermal conductivity and reduced amount of organic impurities, and a PDP manufactured with the same.

2. Description of the Related Art

A plasma display panel (PDP) may refer to a display device capable of forming images by exciting a photoluminescent material with vacuum ultraviolet (VUV) light generated by gas discharge in discharge cells. The PDP may be advantageous in realizing high-resolution images on thin, large screens, thereby providing better display characteristics than, e.g., a cathode ray tube (CRT) display.

The conventional PDP, e.g., a reflective alternating current driven PDP, may include first and second substrates facing each other with a plurality of discharge cells and electrodes therebetween. In particular, the electrodes may be on the first and/or the second substrate, and a dielectric layer may be disposed to coat the electrodes.

The conventional dielectric layer may be formed of a slurry paste including a ceramic material, binder, and organic solvent by, e.g., a painting method, a coating method, or a sheet method. The conventional slurry paste may form a ceramic material layer. The ceramic material layer may be dried and fired, i.e., removal of organic components, in order to form a dielectric layer.

However, the conventional firing process of the ceramic material layer may be costly. Further, the conventional firing process may be insufficient to remove all organic components from the ceramic material layer. For example, a firing process at a temperature of at least about 400° C. may be performed for a substantially long duration in order to only partially break down the binder of the slurry paste into residual carbon, e.g., C, CO, (CH)²⁹, (CH)⁴⁵, and so forth, prior to removal thereof. In this respect, it should be noted that “CH” refers to a hydrocarbon component, and the numerical superscript refers to a molecular weight thereof.

Accordingly, portions of non-decomposed binder may remain in the ceramic material layer, thereby generating a significant source of impurities in the dielectric layer. Further, remaining residual carbon in the dielectric layer may diffuse into a photoluminescent material coated thereon, e.g., due to accelerating ions, electrons, or heat generated during light emission, thereby causing reduced discharge properties, e.g., deteriorated brightness of the light emitted from the photoluminescent material, decreased lifespan of the photoluminescent material, e.g., chemical deterioration of the photoluminescent material, and overall low luminance efficiency of the PDP.

### SUMMARY OF THE INVENTION

Embodiments of the present invention are therefore directed to a composition for a dielectric layer and a plasma display panel (PDP) manufactured therewith, which substantially overcome one or more of the disadvantages of the related art.

It is therefore a feature of embodiments of the present invention to provide a composition for a dielectric layer with a reduced amount of impurities therein.

It is another feature of embodiments of the present invention to provide a PDP with a dielectric layer capable of enhancing luminance efficiency and life span of the PDP.

At least one of the above and other features and advantages of the present invention may be realized by providing a dielectric layer composition, including a ceramic material, a binder, a solvent, and a selenium oxide additive. The selenium oxide additive may be present in an amount of about 1% to about 10 wt % based on a total weight of the dielectric layer composition. The dielectric layer composition may further include an oxide having one or more of vanadium oxide, molybdenum oxide, and/or cerium oxide. The ceramic material may include glass powder. The glass powder may include one or more of a lead oxide, a silicon oxide, an aluminum oxide, a magnesium oxide, and/or a titanium oxide. The binder may include one or more of an acryl-based compound, an epoxy-based compound, and/or a cellulose-based compound. The binder may be a cellulose-based compound, the cellulose-based compound including one or more of ethyl-cellulose-based compound and/or nitro-cellulose-based compound. The solvent may include one or more of ethanol, trimethylpentanediol monoisobutylate, butyl carbitol, butyl cellosolve, butyl carbitol acetate, terpineol, toluene, and/or texanol.

At least one of the above and other features and advantages of the present invention may be further realized by providing a dielectric layer composition including a ceramic material, a binder, a solvent, and an additive, the additive including two or more of a selenium oxide, a vanadium oxide, a molybdenum oxide, and/or a cerium oxide. The additive may be present in an amount of about 1% to about 10% by total weight of the dielectric layer composition. The additive may include three or more of a selenium oxide, a vanadium oxide, a molybdenum oxide, and/or a cerium oxide. The ceramic material may include glass powder. The glass powder may include one or more of a lead oxide, a silicon oxide, an aluminum oxide, a magnesium oxide, and/or a titanium oxide. The binder may include one or more of an acryl-based compound, an epoxy-based compound, and/or a cellulose-based compound. The binder may be a cellulose-based compound, the cellulose-based compound including at one or more of ethyl-cellulose-based compound and/or nitro-cellulose-based compound. The solvent may include one or more of ethanol, trimethylpentanediol monoisobutylate, butyl carbitol, butyl cellosolve, butyl carbitol acetate, terpineol, toluene, and/or texanol.

At least one of the above and other features and advantages of the present invention may be also realized by providing a plasma display panel (PDP), including a first substrate facing a second substrate, a plurality of address and display electrodes between the first and second substrates, at least one dielectric layer between the first and second substrates, the dielectric layer including a selenium oxide additive, barrier ribs between the first and second substrates to define a plurality of discharge cells, and photoluminescent layers in the discharge cells. The selenium oxide additive may be present in an amount of about 1% to about 10% by total weight of the dielectric layer. The dielectric layer may further include an oxide including one or more of a vanadium oxide, a molybdenum oxide, and/or a cerium oxide.

At least one of the above and other features and advantages of the present invention may be further realized by providing a PDP, including a first substrate facing a second substrate, a plurality of address electrodes along a first direction on the first substrate, a plurality of display electrodes along a second direction on the second substrate, the first direction crossing the first direction, barrier ribs between the first and second substrates to define a plurality of discharge cells, photoluminescent layers in the discharge cells, a first dielectric layer on the address electrodes, the dielectric layer facing the discharge cells, and a second dielectric layer on the display electrodes, the second dielectric layer facing the discharge cells, wherein at least one of the first and second dielectric layers includes an additive, the additive including two or more of a selenium oxide, a vanadium oxide, a molybdenum oxide, and/or a cerium oxide. The additive may be present in an amount of about 1% to about 10% by a total weight of the dielectric layer. The additive may include three additives or more of a selenium oxide, a vanadium oxide, a molybdenum oxide, and/or a cerium oxide.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1 illustrates a partial exploded perspective view of a plasma display panel according to an embodiments of the present invention; and

FIG. 2 illustrates a graph of a thermogravimetric analysis of a composition for a dielectric layer according to an embodiment of the present invention as compared to a Comparative Example.

### DETAILED DESCRIPTION OF THE INVENTION

Korean Patent Application No. 10-2007-0005627 filed on Jan. 18, 2007, in the Korean Intellectual Property Office, and entitled: “Composition for Dielectric Layer, and Plasma Display Panel Manufactured with the Same,” is incorporated by reference herein in its entirety.

Embodiments of the present invention will now be described more fully hereinafter with reference to the accompanying drawings, in which exemplary embodiments of the invention are illustrated. Aspects of the invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

An exemplary embodiment of a composition for a dielectric layer according to the present invention will now be described in more detail. The composition for a dielectric layer according to an embodiment of the present invention may include a ceramic material, a binder, a solvent, and at least one oxide additive.

The ceramic material of the dielectric layer composition may include any material suitable for forming a dielectric layer. For example, the ceramic material may include glass powder, such as lead oxide (PbO), silicon oxide (SiOₓ), aluminum oxide (Al₂O₃), magnesium oxide (MgO), titanium oxide (TiO₂), and combinations thereof. The ceramic material may include inorganic glass powder without PbO.

The binder of the dielectric layer composition may include any suitable polymer resin. For example, the polymer resin may include one or more of acryl-based resin, epoxy-based resin, cellulose-based resin, e.g., ethyl cellulose (EC) or nitro cellulose (NC), and so forth.

The solvent of the dielectric layer composition may include any suitable organic solvent. For example, the organic solvent may include one or more of ethanol, trimethylpentanediol monoisobutylate (TPM), butyl carbitol (BC), butyl cellosolve (BC), butyl carbitol acetate (BCA), terpineol (TP), toluene, texanol, and so forth.

The oxide additive of the dielectric layer may include SeO₂. The oxide additive may further include a metal oxide, e.g., one or more of V₂O₅, MoO₃, and/or CeO₂. For example, the oxide additive may include at least two of SeO₂, V₂O₅, MoO₃, and/or CeO₂. In another Example, the oxide additive may include at least three of SeO₂, V₂O₅, MoO₃, and/or CeO₂.

A total amount of the oxide additive employed in the dielectric layer composition may be in a range of from about 1% to about 10% by weight based on a total weight of the dielectric layer composition. When more than one oxide additive is used in the barrier rib composition, the oxide additives may be employed at equal proportions. For example, the selenium oxide and the molybdenum oxide may be mixed at a weight ratio of about 1:1 to form the oxide additive. When the amount of additive is less than about 1% by weight of the total dielectric layer composition, the additive amount may be too low to provide effective removal of residual carbon. When the amount of additive is more than about 10% by weight of the total dielectric layer composition, the viscosity of the dielectric layer composition may be too low to provide effective support to the substrates of the PDP.

Including at least one oxide additive in the dielectric layer composition according to an embodiment of the present invention may be advantageous in facilitating a faster decomposition rate of the binder of the dielectric layer composition at lower temperatures. More specifically, the oxide additive may facilitate heat transfer through the dielectric layer during the firing process regardless of a thickness of the dielectric layer. Accordingly, the heat may weaken binding properties of the binder, e.g., weaken polymeric bonds to facilitate separation of organic components, by increasing the binder decomposition rate at a predetermined temperature. It is noted that removal of the organic solvent may be easier than removal of the binder, and the firing process may not remove the ceramic material.

In addition, without intending to be bound by theory, the oxide additive may not interact chemically with the ceramic material, thereby bonding substantially only to the binder. Accordingly, a small amount of the oxide additive may be sufficient to bond to the binder in order to weaken chemical bonding thereof, thereby accelerating binder decomposition and removal. Accordingly, dielectric layers formed of the dielectric layer composition according to an embodiment of the present invention, i.e., with an oxide additive, may include a significantly lower amount of impurities.

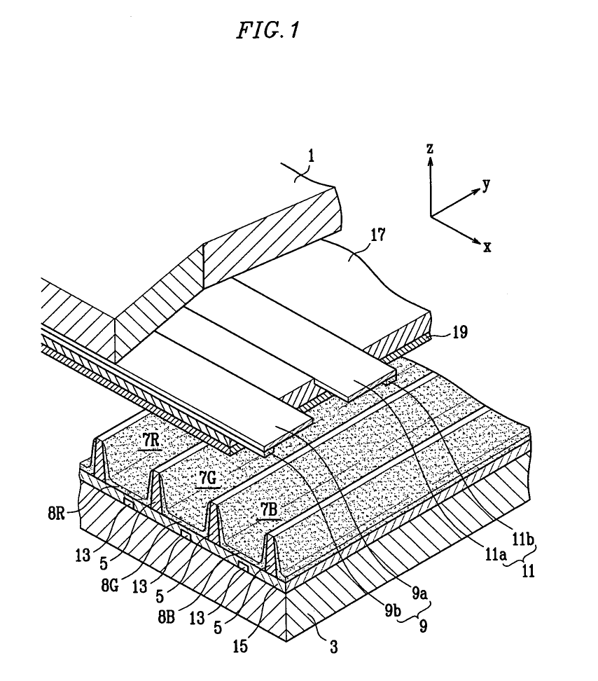

According to another exemplary embodiment of the present invention, a PDP may be formed to include at least one dielectric layer formed of the dielectric layer composition described above. More specifically, as illustrated in FIG. 1, the PDP may include a first substrate 3, a second substrate 1 facing the first substrate, a plurality of address electrodes 13 in a first direction, i.e., along the y-axis, on the first substrate 3, and a plurality of display electrodes in a second direction, i.e., along the x-axis, on the second substrate 1. The address electrodes 13 may be coated with a first dielectric layer 15, and the display electrodes may be coated with a second dielectric layer 17. The PDP may further include barrier ribs 5 between the first and second substrates 3 and 1, and a protective layer 19 on the second dielectric layer 17.

The first and second substrates 3 and 1 may be any suitable substrates. The first dielectric layer 15 and/or the second dielectric layer 17 may be formed of the dielectric layer composition described previously, and therefore, detailed description thereof will not be repeated.

The barrier ribs 5 of the PDP may be formed on the first dielectric layer 15 to define discharge cells 7R, 7G, and 7B, so red (R), green (G), and blue (B) photoluminescent layers 8R, 8G, and 8B may be disposed therein, respectively. The discharge cells 7R, 7G, and 7B may be positioned at intersection points of the address electrodes 13 and the display electrodes. The barrier ribs 5 may be formed in any suitable shape. For example, the barrier ribs 5 may be formed as an open type, e.g., a stripe-pattern, or as a closed type, e.g., a waffle-pattern, a matrix-pattern, a delta-pattern, and so forth. A cross-sectional area of each barrier rib 5 in the horizontal direction, i.e., the xy-plane, may be, e.g., quadrangular, triangular, pentagonal, circular, oval, and so forth.

The display electrodes of the PDP may include pairs of first display electrodes 9 and second display electrodes 11. Each pair of display electrodes, i.e., a first display electrode 9 and a second display electrode 11, may include transparent electrodes 9a and 11a, respectively, and bus electrodes 9b and 11b, respectively. The display electrodes may be disposed in a direction crossing the address electrodes 13, i.e., along the x-axis.

Accordingly, an address voltage (Va) may be applied between the address electrodes 13 and the display electrodes to generate an address discharge to select discharge cells to operate. Similarly, a sustain voltage (Vs) may be applied between pairs of display electrodes to generate sustain discharge between selected discharge cells. The sustain discharge in selected discharge cells may excite a respective photoluminescent layer therein to emit visible light toward the second substrate 1 to display an image.

The PDP may have improved discharge efficiency and brightness maintenance ratio due to reduced amount of impurities in the dielectric layers thereof. Further, the PDP may be formed at lower temperatures, i.e., a lower firing temperature, thereby exhibiting reduced damage generated by high temperatures.

### EXAMPLES

### Example 1

a composition for a dielectric layer was prepared by mixing 70 g of ZnO—B₂O₃—SiO₂—Al₂O₃-based glass powder, 5 g of ethyl cellulose (EC), i.e., a binder, resin, 20 g of butyl carbitol acetate (BCA), i.e., an organic solvent, and 5 g of SeO₂.

1 g of the dielectric layer composition was set as 100% weight at room temperature, and the dielectric layer composition was heated at a rate of 10° C./min until the dielectric layer composition reached a temperature of 600° C. The weight of the dielectric layer composition was measured and recorded at regular intervals relatively to the initial 100% weight to perform a thermogravimetric analysis (TGA).

### Comparative Example 1

a composition for a dielectric layer was prepared according to the method of Example 1, with the exception of using no SeO₂. TGA was performed on the Comparative Example 1 and compared to Example 1.

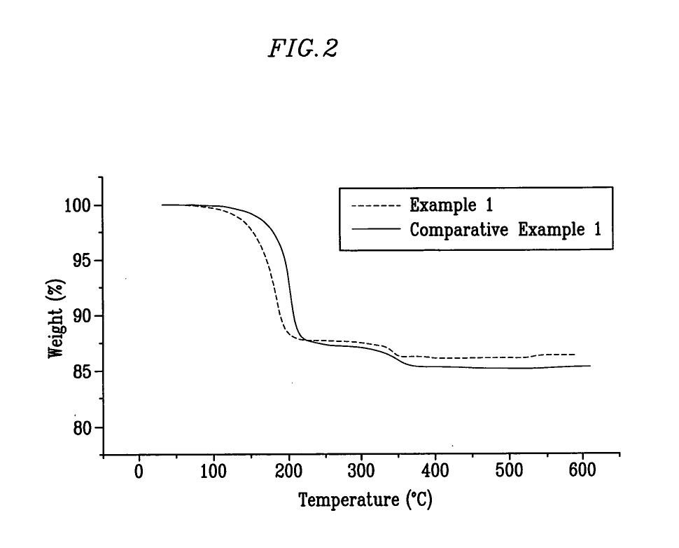

The TGA results of Example 1 and comparative Example 1 are reported in FIG. 2. As illustrated in FIG. 2, the composition for a dielectric layer of Example 1 exhibited faster thermal decomposition characteristics than the composition of the Comparative Example 1. Accordingly, a composition for a dielectric layer that includes an additive according to an embodiment of the present invention, i.e., CeO₂, SeO₂, V₂O₅, and/or MoO₃, may effectively remove residual carbon from a polymer resin, thereby improving luminous efficiency and luminance maintenance rate of a PDP.

### Examples 2 to 13

twelve (12) dielectric layer compositions containing ZnO—B₂O₃—SiO₂—Al₂O₃-based glass powder, EC binder, BCA, and an oxide additive were mixed according to proportions indicated in Table 1 below. Each dielectric layer composition of Examples 2-13 was analyzed for an amount of residual carbon remaining therein. Further, each dielectric layer composition was processed to form a dielectric layer and incorporated into a PDP, so that each PDP was evaluated in terms of brightness maintenance ratio and number of black spots.

### Comparative Examples 2-5

four (4) dielectric layer compositions containing ZnO—B₂O₃—SiO₂—Al₂O₃-based glass powder, EC binder, BCA, and an oxide additive were mixed according to the proportions indicated in Table 1 below. The dielectric layer compositions of Comparative Examples 2-5 were analyzed for an amount of residual carbon remaining therein. Further, the dielectric layer composition was processed to form a dielectric layer and incorporated into a PDP, so that the PDP was evaluated in terms of brightness maintenance ratio and number of black spots.

TABLE 1

| | Glass | EC | Oxide Additive | | | |
|---|---|---|---|---|---|---|
| | powder | Binder | | Weight | Weight | BCA |
| | (kg) | (kg) | Kind | ratio | (kg) | (kg) |
| Comparative | 20 | 1.2 | — | — | — | 5.5 |
| Example 2 | | | | | | |
| Comparative | 20 | 1.2 | V₂O₅ | — | 0.27 | 5.23 |
| Example 3 | | | | | | |
| Comparative | 19.5 | 1.2 | MoO₃ | — | 0.53 | 5.47 |
| Example 4 | | | | | | |
| Comparative | 19.5 | 1.2 | CeO₂ | — | 0.8 | 5.2 |
| Example 5 | | | | | | |
| Example 2 | 20 | 1.2 | SeO₂ | — | 0.27 | 5.23 |
| Example 3 | 18.8 | 1.2 | SeO₂, V₂O₅ | 1:1 | 1.07 | 5.63 |
| Example 4 | 18.8 | 1.2 | MoO₃, CeO₂ | 1:1 | 1.07 | 5.63 |
| Example 5 | 18.0 | 1.2 | SeO₂, CeO₂ | 1:1 | 1.34 | 6.17 |
| Example 6 | 18.0 | 1.2 | V₂O₅, MoO₃ | 1:1 | 1.34 | 6.17 |
| Example 7 | 17.6 | 1.2 | SeO₂, MoO₃ | 1:1 | 1.87 | 6.03 |
| Example 8 | 17.6 | 1.2 | V₂O₅, CeO₂ | 1:1 | 1.87 | 6.03 |
| Example 9 | 17.2 | 1.2 | SeO₂, V₂O₅, | 1:1:1 | 2.14 | 6.16 |
| | | | MoO₃ | | | |
| Example 10 | 17.2 | 1.2 | SeO₂, V₂O₅, | 1:1:1 | 2.14 | 6.16 |
| | | | CeO₂ | | | |
| Example 11 | 17.2 | 1.2 | SeO₂, | 1:1:1 | 2.14 | 6.16 |
| | | | MoO₃, CeO₂ | | | |
| Example 12 | 16.9 | 1.2 | V₂O₅, | 1:1:1 | 2.67 | 5.93 |
| | | | MoO₃, CeO₂ | | | |
| Example 13 | 16.9 | 1.2 | SeO₂, V₂O₅, | 1:1:1:1 | 2.67 | 5.93 |
| | | | MoO₃, CeO₂ | | | |

Manufacturing of a PDP: each dielectric layer composition of Examples 2-13 and Comparative Examples 2-5 was coated on a first substrate of a PDP to coat address electrodes. The composition was fired at 560° C. for 15 minutes to form a first dielectric layer. Barrier ribs having a predetermined pattern were formed thereon to a predetermined height to define discharge cells.

Next, photoluminescent layers were prepared. Six (6) parts by weight of EC were mixed with hundred (100) parts by weight of a mixture of BCA/terpineol at a weight ratio of 4:6. Forty (40) parts by weight of BaMgAl₁₀O₁₇:Eu blue photoluminescent were mixed with hundred (100) parts by weight of the BCA/terpineol mixture to form a blue photoluminescent paste. Red and green photoluminescent pastes were prepared by using (Y,Gd)BO₃:Eu and ZnSiO₄:Mn, respectively, instead of BaMgAl₁₀O₁₇:Eu. The photoluminescent pastes were coated on bottom and side surfaces of the discharge cells to form photoluminescent layers. Subsequently, the first substrate was dried at 200° C. and fired at 500° C.

Next, the composition for a dielectric layer was coated on a second substrate to coat display electrodes, and was fired at 550° C. for 15 minutes to form a second dielectric layer. A protective layer was formed on the second dielectric layer, followed by assembling, sealing, ventilating, charging a discharge gas, and aging the first and second substrates to prepare a PDP.

The residual amount of carbon was determined by thermal desorption spectroscopy (TDS). The dielectric layer compositions of Examples 2-13 and Comparative Examples 2-5 were heated under ultrahigh vacuum conditions and evaluated with a mass spectrometer. Masses of C, CO, (CH)²⁹, and (CH)⁴⁵ were determined for each sample. TDS results for each carbon species are reported in Table 2 below.

The brightness maintenance ratio was determined with respect to a full white state of the PDP. The initial brightness was set for each PDP as a relative brightness with respect to brightness of PDP employing the composition of Comparative Example 2. Next, a contact brightness meter (CA-100 plus by Minolta) was used to evaluate brightness of each sample after every 100 hours. Brightness of each sample after 500 hours was compared to a respective initial brightness to determine brightness maintenance ratio. Brightness results are reported in Table 2 below.

The number of black spots was determined by counting the number of broken barrier ribs due to vibration of the PDP. The PDP was vibrated at 1.50 Grm in the vertical direction for 2 hours, while an external impact from a height of 1 m was applied thereto three times. The number of black spots was evaluated in order to determine whether use of an oxide additive weakens the barrier ribs and reduces support of the first/second PDP substrates. Results are reported in Table 2 below

TABLE 2

| | | | | | | Brightness | |
|---|---|---|---|---|---|---|---|
| | | | | | | maintenance | Number |
| | Residual carbon content (ppm) | | | | Initial | Ratio after | of |
| | C | CO | CH(29) | CH(45) | brightness | 500 hr | black spot |
| Comparative | 1.28 × 10⁻⁴ | 2.21 × 10⁻⁴ | 8.63 × 10⁻⁴ | 2.24 × 10⁻⁵ | 100.0% | 81.7% | 0 |
| Example 2 | | | | | | | |
| Comparative | 7.86 × 10⁻⁶ | 2.38 × 10⁻⁶ | 4.75 × 10⁻⁶ | 1.26 × 10⁻⁷ | 106.1% | 84.9% | 0 |
| Example 3 | | | | | | | |
| Comparative | 8.12 × 10⁻⁶ | 6.14 × 10⁻⁶ | 1.83 × 10⁻⁶ | 4.75 × 10⁻⁷ | 106.6% | 84.1% | 0 |
| Example 4 | | | | | | | |
| Comparative | 6.32 × 10⁻⁶ | 3.36 × 10⁻⁶ | 6.22 × 10⁻⁶ | 9.16 × 10⁻⁷ | 106.9% | 85.6% | 0 |
| Example 5 | | | | | | | |
| Example 2 | 4.60 × 10⁻⁶ | 5.96 × 10⁻⁶ | 3.75 × 10⁻⁶ | 5.61 × 10⁻⁷ | 105.7% | 83.7% | 0 |
| Example 3 | 7.17 × 10⁻⁶ | 6.68 × 10⁻⁶ | 3.52 × 10⁻⁶ | 4.81 × 10⁻⁷ | 107.1% | 85.4% | 0 |
| Example 4 | 7.87 × 10⁻⁶ | 5.69 × 10⁻⁶ | 6.43 × 10⁻⁶ | 5.43 × 10⁻⁷ | 106.8% | 85.8% | 0 |
| Example 5 | 7.62 × 10⁻⁶ | 4.55 × 10⁻⁶ | 2.91 × 10⁻⁶ | 6.24 × 10⁻⁷ | 108.4% | 85.6% | 0 |
| Example 6 | 7.98 × 10⁻⁶ | 7.29 × 10⁻⁶ | 2.52 × 10⁻⁶ | 1.62 × 10⁻⁷ | 109.8% | 86.3% | 0 |
| Example 7 | 5.48 × 10⁻⁶ | 3.21 × 10⁻⁶ | 6.94 × 10⁻⁶ | 7.66 × 10⁻⁷ | 107.2% | 86.1% | 0 |
| Example 8 | 2.42 × 10⁻⁶ | 1.26 × 10⁻⁶ | 1.88 × 10⁻⁶ | 2.64 × 10⁻⁷ | 103.1% | 85.8% | 0 |
| Example 9 | 3.79 × 10⁻⁶ | 4.69 × 10⁻⁶ | 5.17 × 10⁻⁶ | 7.72 × 10⁻⁷ | 107.7% | 86.3% | 0 |
| Example 10 | 6.79 × 10⁻⁶ | 5.28 × 10⁻⁶ | 4.34 × 10⁻⁶ | 1.9 × 10⁻⁷ | 106.9% | 85.2% | 0 |
| Example 11 | 5.17 × 10⁻⁶ | 3.37 × 10⁻⁶ | 9.56 × 10⁻⁶ | 7.82 × 10⁻⁷ | 107.9% | 85.9% | 0 |
| Example 12 | 6.74 × 10⁻⁶ | 5.84 × 10⁻⁶ | 6.63 × 10⁻⁶ | 3.76 × 10⁻⁷ | 108.1% | 85.6% | 0 |
| Example 13 | 6.34 × 10⁻⁶ | 3.48 × 10⁻⁶ | 5.98 × 10⁻⁶ | 7.14 × 10⁻⁷ | 106.4% | 84.6% | 0 |

As shown in Table 2 above, the residual carbon content in Examples 2-13 was significantly lower as compared to the residual carbon content in Comparative Examples 2-5. Further, a PDP including a composition for a dielectric layer according to Examples 2-13 exhibited about 5% to about 10% increase of brightness increase as compared to the initial brightness of Comparative Examples 2-5. Similarly, a PDP including a composition for a dielectric layer according to Examples 2-13 exhibited about 3% to about 7% in increase of luminance maintenance rate. Finally, the number of black spots was not increased due to use of an oxide additive.

The dielectric layer composition according to embodiments of the present invention may be advantageous in providing an increased thermal conductivity and increased separation of organic components due to use of an oxide additive, thereby providing improved removal of residual carbon at low firing temperature. A PDP including dielectric layers formed of the composition for a dielectric layer may exhibit reduced damage due to manufacturing at a lower firing temperature and a reduced amount of impurities due to improved removal of residual carbon. Accordingly, the PDP may exhibit high luminous efficiency and luminance maintenance rate. In addition, the PDP may be manufactured with the same equipment and within the same time as a conventional PDP.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A dielectric layer composition, comprising a ceramic material, a binder, a solvent, and a selenium oxide additive.

2. The dielectric layer composition as claimed in claim 1, wherein the selenium oxide additive is present in an amount of about 1% to about 10 wt % based on a total weight of the dielectric layer composition.

3. The dielectric layer composition as claimed in claim 1, wherein the dielectric layer composition further comprises an oxide including one or more of vanadium oxide, molybdenum oxide, and/or cerium oxide.

4. The dielectric layer composition as claimed in claim 1, wherein the ceramic material includes glass powder.

5. The dielectric layer composition as claimed in claim 4, wherein the glass powder includes one or more of a lead oxide, a silicon oxide, an aluminum oxide, a magnesium oxide, and/or a titanium oxide.

6. The dielectric layer composition as claimed in claim 1, wherein the binder includes one or more of an acryl-based compound, an epoxy-based compound, and/or a cellulose-based compound.

7. The dielectric layer composition as claimed in claim 6, wherein the binder is a cellulose-based compound, the cellulose-based compound including one or more of ethyl-cellulose-based compound and/or nitro-cellulose-based compound.

8. The dielectric layer composition as claimed in claim 1, wherein the solvent includes one or more of ethanol, trimethylpentanediol monoisobutylate, butyl carbitol, butyl cellosolve, butyl carbitol acetate, terpineol, toluene, and/or texanol.

9. A dielectric layer composition comprising, a ceramic material, a binder, a solvent, and an additive, the additive including two or more of a selenium oxide, a vanadium oxide, a molybdenum oxide, and/or a cerium oxide.

10. The dielectric layer composition as claimed in claim 9, wherein the additive is present in an amount of about 1% to about 10% by total weight of the dielectric layer composition.

11. The dielectric layer composition as claimed in claim 9, wherein the additive includes three or more of a selenium oxide, a vanadium oxide, a molybdenum oxide, and/or a cerium oxide.

12. The dielectric layer composition as claimed in claim 9, wherein the ceramic material includes glass powder.

13. The dielectric layer composition as claimed in claim 12, wherein the glass powder includes one or more of a lead oxide, a silicon oxide, an aluminum oxide, a magnesium oxide, and/or a titanium oxide.

14. The dielectric layer composition as claimed in claim 9, wherein the binder includes one or more of an acryl-based compound, an epoxy-based compound, and/or a cellulose-based compound.

15. The dielectric layer composition as claimed in claim 14, wherein the binder is a cellulose-based compound, the cellulose-based compound including at one or more of ethyl-cellulose-based compound and/or nitro-cellulose-based compound.

16. The composition as claimed in claim 9, wherein the solvent includes one or more of ethanol, trimethylpentanediol monoisobutylate, butyl carbitol, butyl cellosolve, butyl carbitol acetate, terpineol, toluene, and/or texanol.

17. A plasma display panel (PDP) comprising:
a first substrate and a second substrate arranged opposite to each other;
address electrodes and a first dielectric layer covering the address electrodes, disposed on the first substrate;
display electrodes disposed in a direction crossing the address electrodes, and a second dielectric layer covering the display electrodes disposed on the second substrate;
barrier ribs disposed in a space between the first substrate and the second substrate to partition a plurality of discharge cells; and
phosphor layers disposed in the discharge cells,
wherein at least one of the first and second dielectric layers comprises a selenium oxide additive.

18. The PDP as claimed in claim 17, wherein the selenium oxide additive is present in an amount of about 1% to about 10% by total weight of the dielectric layer.

19. The PDP as claimed in claim 17, wherein the dielectric layer further comprises an oxide including one or more of a vanadium oxide, a molybdenum oxide, and/or a cerium oxide.

20. A plasma display panel (PDP), comprising:
a first substrate facing a second substrate;
a plurality of address electrodes along a first direction on the first substrate;
a plurality of display electrodes along a second direction on the second substrate, the first direction crossing the first direction;
barrier ribs between the first and second substrates to define a plurality of discharge cells;
photoluminescent layers in the discharge cells;
a first dielectric layer on the address electrodes, the dielectric layer facing the discharge cells; and
a second dielectric layer on the display electrodes, the second dielectric layer facing the discharge cells,
wherein at least one of the first and second dielectric layers includes an additive, the additive including two or more of a selenium oxide, a vanadium oxide, a molybdenum oxide, and/or a cerium oxide.

21. The plasma display panel as claimed in claim 20, wherein the additive is present in an amount of about 1% to about 10% by a total weight of the dielectric layer.

22. The plasma display panel as claimed in claim 20, wherein the additive includes three additives or more of a selenium oxide, a vanadium oxide, a molybdenum oxide, and/or a cerium oxide.
